(19) United States
(12) Patent Application Publication
(10) Pub. No.: US 2020/0163079 A1
(43) Pub. Date: May 21, 2020

(54) METHOD FOR TRANSMITTING SIGNAL ACCORDING TO RESOURCE ALLOCATION PRIORITY, AND TERMINAL THEREFOR

(71) Applicant: LG Electronics Inc., Seoul (KR)

(72) Inventors: Kukheon CHOI, Seoul (KR); Jiwon KANG, Seoul (KR); Kyuseok KIM, Seoul (KR); Kilbom LEE, Seoul (KR); Minki AHN, Seoul (KR)

(21) Appl. No.: 16/629,873

(22) PCT Filed: Jul. 27, 2018
(86) PCT No.: PCT/KR2018/008543

§ 371 Date: Jan. 9, 2020

Related U.S. Application Data
(60) Provisional application No. 62/537,490, filed on Jul. 27, 2017.
(60) Provisional application No. 62/543,384, filed on Aug. 10, 2017.
(60) Provisional application No. 62/543,986, filed on Aug. 11, 2017.

(51) Int. Cl. H04W 72/04; H04W 72/10; H04L 5/00

(52) U.S. Cl. CPC H04W 72/0413; H04L 5/0048; H04W 72/10

(57) ABSTRACT

A method for a terminal transmitting a signal according to a resource allocation priority may comprise the steps of: when a sounding reference signal (SRS) symbol and a physical uplink control channel (PUCCH) symbol are configured so as to overlap, transmitting an SRS in a non-overlapping symbol; and dropping the transmission of the SRS in the overlapping symbol. The present invention can improve communication performance by being able to carry out transmission according to a resource allocation priority rule, when the SRS and PUCCH resource areas overlap.

### TECHNICAL FIELD

The present invention relates to wireless communication and, more particularly, to a method of transmitting a signal according to a resource allocation priority and a user equipment therefor.

### BACKGROUND ART

When a new radio access technology (RAT) system is introduced, as more and more communication devices require larger communication capacity, there is a need for improved mobile broadband communication as compared to existing RAT.

In addition, massive machine type communications (MTC) connected to a plurality of devices and things to provide various services anytime and anywhere is one of main issues to be considered in next-generation communication. In addition, communication system design considering services/UEs sensitive to reliability and latency has been discussed. As such, New RAT will provide services considering enhanced mobile broadband communication (eMBB), massive MTC (mMTC), URLLC (Ultra-Reliable Low-Latency Communication), etc. In a next-generation 5G system, scenarios may be divided into Enhanced Mobile BroadBand (eMBB)/Ultra-reliable Machine-Type Communications (uMTC)/Massive Machine-Type Communications (mMTC), etc. eMBB is a next-generation mobile communication scenario having high spectrum efficiency, high user experienced data rate, high peak data rate, etc., uMTC is a next-generation mobile communication scenario having ultra-reliability, ultra-low latency, ultra-high availability, etc. (e.g., V2X, emergency service, remote control), and mMTC is a next-generation mobile communication scenario having low cost, low energy, short packet, and massive connectivity (e.g., IoT).

### DISCLOSURE

### Technical Problem

An aspect of the present disclosure is to provide a method of transmitting a signal according to the resource allocation priority of the signal.

Another aspect of the present disclosure is to provide a user equipment (UE) for transmitting a signal according to the resource allocation priority of the signal.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

To achieve the object of the present disclosure, in one embodiment of the present disclosure, a method of transmitting a signal according to a resource allocation priority by a user equipment (UE) may comprise: when sounding reference signal (SRS) symbols and a physical uplink control channel (PUCCH) symbol are configured to overlap with each other, transmitting an SRS in a non-overlapped symbol; and dropping an SRS transmission in an overlapped symbol. The method may further comprise transmitting the PUCCH symbol in the overlapped symbol. The SRS symbols may include a plurality of consecutive symbols. The PUCCH symbol may be a periodic PUCCH symbol or an aperiodic PUCCH symbol.

To achieve the object of the present disclosure, in another embodiment of the present disclosure, a method of transmitting a signal according to a resource allocation priority by a user equipment (UE) may comprise: when an aperiodic sounding reference signal (SRS) and a physical uplink control channel (PUCCH) for a request related to beam failure are configured to overlap with each other in a resource area, transmitting the PUCCH for the request related to beam failure; and dropping a transmission of the aperiodic SRS. The PUCCH for the request related to beam failure may be a short PUCCH.

To achieve the object of the present disclosure, in one embodiment of the present disclosure, a user equipment for transmitting a signal according to a resource allocation priority may comprise: a transmitter; and a processor, wherein the processor is configured to, when sounding reference signal (SRS) symbols and a physical uplink control channel (PUCCH) symbol are configured to overlap with each other, control the transmitter to transmit an SRS in a non-overlapped symbol and drop an SRS transmission in an overlapped symbol. The processor may control the transmitter to transmit the PUCCH symbol in the overlapped symbol.

To achieve the object of the present disclosure, in another embodiment of the present disclosure, a user equipment for transmitting a signal according to a resource allocation priority may comprise: a transmitter; and a processor, wherein the processor is configured to, when an aperiodic sounding reference signal (SRS) and a physical uplink control channel (PUCCH) for a request related to beam failure are configured to overlap with each other in a resource area, control the transmitter to transmit the PUCCH for the request related to beam failure and drop a transmission of the aperiodic SRS. The PUCCH for the request related to beam failure may be a short PUCCH.

### Advantageous Effects

According to an embodiment of the present disclosure, the method of, when the resource areas of a sounding reference signal (SRS) and a physical uplink control channel (PUCCH) overlap with each other, transmitting the SRS and the PUCCH according to their resource allocation priorities or in frequency division multiplexing (FDM) may increase communication performance.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The accompanying drawings, which are included to provide a further understanding of the invention, illustrate embodiments of the invention and together with the description serve to explain the principle of the invention. In the drawings:

FIG. 1 is a block diagram showing the configuration of a base station (BS) 105 and a user equipment (UE) 110 in a wireless communication system 100;

FIG. 2a is a view showing TXRU virtualization model option 1 (sub-array model) and FIG. 2b is a view showing TXRU virtualization model option 2 (full connection model);

FIG. 3 is a block diagram for hybrid beamforming;

FIG. 4 is a view showing an example of beams mapped to BRS symbols in hybrid beamforming;

FIG. 5 is a view showing symbol/sub-symbol alignment between different numerologies;

FIG. 6 is a view showing an LTE hopping pattern (nₛ=1-->nₛ=4);

FIG. 7 is a diagram illustrating multiplexing between an SRS and a PUCCH (symbol-level hopping) according to Embodiment 1 of Proposal 1.

FIG. 8 is a diagram illustrating an exemplary PUCCH hopping pattern.

FIG. 9 is a diagram illustrating exemplary application of PUCCH candidate position indexes in an embodiment of Proposal 3.

FIG. 10 is a diagram illustrating an exemplary method of allocating VRBs to an SRS and a PUCCH and then mapping the VRBs to PRBs, when the SRS and the PUCCH are multiplexed.

FIG. 11 is a diagram illustrating exemplary TDM (implicit arrangement) among a periodic PUCCH, an aperiodic PUCCH, and a periodic SRS.

FIG. 12 is a diagram illustrating exemplary transmission in case of overlap between an SRS for Rx beam sweeping and a PUCCH.

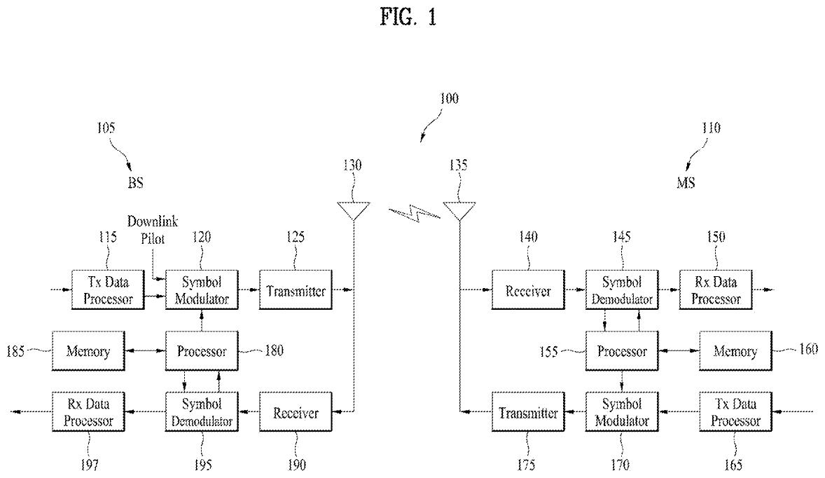

### BEST MODE

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details. For instance, although the following descriptions are made in detail on the assumption that a mobile communication system includes 3GPP LTE system, the following descriptions are applicable to other random mobile communication systems in a manner of excluding unique features of the 3GPP LTE.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a user equipment (UE), a mobile station (MS), an advanced mobile station (AMS) and the like. And, assume that a base station (BS) is a common name of such a random node of a network stage communicating with a terminal as a Node B (NB), an eNode B (eNB), an access point (AP), gNode B and the like. Although the present specification is described based on IEEE 802.16m system, contents of the present invention may be applicable to various kinds of other communication systems.

In a mobile communication system, a user equipment is able to receive information in downlink and is able to transmit information in uplink as well. Information transmitted or received by the user equipment node may include various kinds of data and control information. In accordance with types and usages of the information transmitted or received by the user equipment, various physical channels may exist.

The following descriptions are usable for various wireless access systems including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented by such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. UTRA is a part of UMTS (Universal Mobile Telecommunications System). 3GPP (3rd Generation Partnership Project) LTE (long term evolution) is a part of E-UMTS (Evolved UMTS) that uses E-UTRA. The 3GPP LTE employs OFDMA in DL and SC-FDMA in UL. And, LTE-A (LTE-Advanced) is an evolved version of 3GPP LTE.

Moreover, in the following description, specific terminologies are provided to help the understanding of the present invention. And, the use of the specific terminology can be modified into another form within the scope of the technical idea of the present invention.

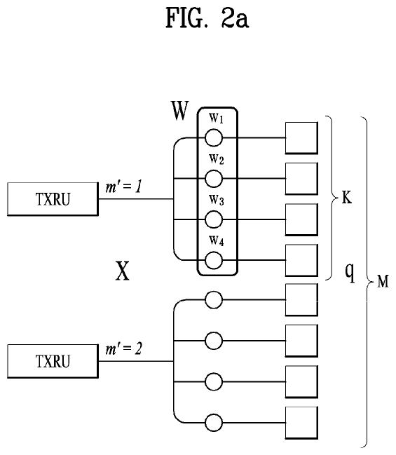

FIG. 2 is a block diagram for configurations of a base station 105 and a user equipment 110 in a wireless communication system 100.

Although one base station 105 and one user equipment 110 (D2D user equipment included) are shown in the drawing to schematically represent a wireless communication system 100, the wireless communication system 100 may include at least one base station and/or at least one user equipment.

Referring to FIG. 2, a base station 105 may include a transmitted (Tx) data processor 115, a symbol modulator 120, a transmitter 125, a transceiving antenna 130, a processor 180, a memory 185, a receiver 190, a symbol demodulator 195 and a received data processor 197. And, a user equipment 110 may include a transmitted (Tx) data processor 165, a symbol modulator 170, a transmitter 175, a transceiving antenna 135, a processor 155, a memory 160, a receiver 140, a symbol demodulator 155 and a received data processor 150. Although the base station/user equipment 105/110 includes one antenna 130/135 in the drawing, each of the base station 105 and the user equipment 110 includes a plurality of antennas. Therefore, each of the base station 105 and the user equipment 110 of the present invention supports an MIMO (multiple input multiple output) system. And, the base station 105 according to the present invention may support both SU-MIMO (single user-MIMO) and MU-MIMO (multi user-MIMO) systems.

In downlink, the transmission data processor 115 receives traffic data, codes the received traffic data by formatting the received traffic data, interleaves the coded traffic data, modulates (or symbol maps) the interleaved data, and then provides modulated symbols (data symbols). The symbol modulator 120 provides a stream of symbols by receiving and processing the data symbols and pilot symbols.

The symbol modulator 120 multiplexes the data and pilot symbols together and then transmits the multiplexed symbols to the transmitter 125. In doing so, each of the transmitted symbols may include the data symbol, the pilot symbol or a signal value of zero. In each symbol duration, pilot symbols may be contiguously transmitted. In doing so, the pilot symbols may include symbols of frequency division multiplexing (FDM), orthogonal frequency division multiplexing (OFDM), or code division multiplexing (CDM).

The transmitter 125 receives the stream of the symbols, converts the received stream to at least one or more analog signals, additionally adjusts the analog signals (e.g., amplification, filtering, frequency upconverting), and then generates a downlink signal suitable for a transmission on a radio channel. Subsequently, the downlink signal is transmitted to the user equipment via the antenna 130.

In the configuration of the user equipment 110, the receiving antenna 135 receives the downlink signal from the base station and then provides the received signal to the receiver 140. The receiver 140 adjusts the received signal (e.g., filtering, amplification and frequency downconverting), digitizes the adjusted signal, and then obtains samples. The symbol demodulator 145 demodulates the received pilot symbols and then provides them to the processor 155 for channel estimation.

The symbol demodulator 145 receives a frequency response estimated value for downlink from the processor 155, performs data demodulation on the received data symbols, obtains data symbol estimated values (i.e., estimated values of the transmitted data symbols), and then provides the data symbols estimated values to the received (Rx) data processor 150. The received data processor 150 reconstructs the transmitted traffic data by performing demodulation (i.e., symbol demapping, deinterleaving and decoding) on the data symbol estimated values.

The processing by the symbol demodulator 145 and the processing by the received data processor 150 are complementary to the processing by the symbol modulator 120 and the processing by the transmission data processor 115 in the base station 105, respectively.

In the user equipment 110 in uplink, the transmission data processor 165 processes the traffic data and then provides data symbols. The symbol modulator 170 receives the data symbols, multiplexes the received data symbols, performs modulation on the multiplexed symbols, and then provides a stream of the symbols to the transmitter 175. The transmitter 175 receives the stream of the symbols, processes the received stream, and generates an uplink signal. This uplink signal is then transmitted to the base station 105 via the antenna 135.

In the base station 105, the uplink signal is received from the user equipment 110 via the antenna 130. The receiver 190 processes the received uplink signal and then obtains samples. Subsequently, the symbol demodulator 195 processes the samples and then provides pilot symbols received in uplink and a data symbol estimated value. The received data processor 197 processes the data symbol estimated value and then reconstructs the traffic data transmitted from the user equipment 110.

The processor 155/180 of the user equipment/base station 110/105 directs operations (e.g., control, adjustment, management, etc.) of the user equipment/base station 110/105. The processor 155/180 may be connected to the memory unit 160/185 configured to store program codes and data. The memory 160/185 is connected to the processor 155/180 to store operating systems, applications and general files.

The processor 155/180 may be called one of a controller, a microcontroller, a microprocessor, a microcomputer and the like. And, the processor 155/180 may be implemented using hardware, firmware, software and/or any combinations thereof. In the implementation by hardware, the processor 155/180 may be provided with such a device configured to implement the present invention as ASICs (application specific integrated circuits), DSPs (digital signal processors), DSPDs (digital signal processing devices), PLDs (programmable logic devices), FPGAs (field programmable gate arrays), and the like.

Meanwhile, in case of implementing the embodiments of the present invention using firmware or software, the firmware or software may be configured to include modules, procedures, and/or functions for performing the above-explained functions or operations of the present invention. And, the firmware or software configured to implement the present invention is loaded in the processor 155/180 or saved in the memory 160/185 to be driven by the processor 155/180.

Layers of a radio protocol between a user equipment/base station and a wireless communication system (network) may be classified into 1st layer L1, 2nd layer L2 and 3rd layer L3 based on 3 lower layers of OSI (open system interconnection) model well known to communication systems. A physical layer belongs to the 1st layer and provides an information transfer service via a physical channel. RRC (radio resource control) layer belongs to the 3rd layer and provides control radio resourced between UE and network. A user equipment and a base station may be able to exchange RRC messages with each other through a wireless communication network and RRC layers.

In the present specification, although the processor 155/180 of the user equipment/base station performs an operation of processing signals and data except a function for the user equipment/base station 110/105 to receive or transmit a signal, for clarity, the processors 155 and 180 will not be mentioned in the following description specifically. In the following description, the processor 155/180 can be regarded as performing a series of operations such as a data processing and the like except a function of receiving or transmitting a signal without being specially mentioned.

First, SRS transmission in a 3GPP LTE/LTE-A system will be described in Table 1 below.

TABLE 1

A UE shall transmit Sounding Reference Symbol (SRS) on
per serving cell SRS resources based on two trigger types:
trigger type 0: higher layer signalling
trigger type 1: DCI formats 0/4/1A for FDD and TDD and
DCI formats 2B/2C/2D for TDD.
In case both trigger type 0 and trigger type 1 SRS
transmissions would occur in the same subframe in the same
serving cell, the UE shall only transmit the trigger type 1
SRS transmission.
A UE may be configured with SRS parameters for trigger
type 0 and trigger type 1 on each serving cell. The following
SRS parameters are serving cell specific and semi-statically
configurable by higher layers for trigger type 0 and for trigger
type 1.
Transmission comb k̅_{TC}, as defined in subclause 5.5.3.2 of [3]
for trigger type 0 and each configuration of trigger type 1
Starting physical resource block assignment n_{RRC}, as defined
in subclause 5.5.3.2 of [3] for trigger type 0 and each
configuration of trigger type 1
duration: single or indefinite (until disabled), as defined in
[11] for trigger type 0 srs-ConfigIndex I_{SRS} for SRS periodicity
T_{SRS} and SRS subframe offset T_{offset}, as defined in Table 8.2-1
and Table 8.2-2 for trigger type 0 and SRS periodicity
T_{SRS,1}, and SRS subframe offset T_{SRS,1}, as defined in
Table 8.2-4 and Table 8.2-5 trigger type 1
SRS bandwidth B_{SRS}, as defined in subclause 5.5.3.2 of [3] for
trigger type 0 and each configuration of trigger type 1
Frequency hopping bandwidth, bhop, as defined in subclause
5.5.3.2 of [3] for trigger type 0
Cyclic shift n_{SRS}^{cs}, as defined in subclause 5.5.3.1 of [3] for
trigger type 0 and each configuration of trigger type 1
Number of antenna ports Nₚ for trigger type 0 and each
configuration of trigger type 1
For trigger type 1 and DCI format 4 three sets of SRS
parameters, srs-ConfigApDCI-Format4, are configured by
higher layer signalling. The 2-bit SRS request field [4] in
DCI format 4 indicates the SRS parameter set given in
Table 8.1-1. For trigger type 1 and DCI format 0, a single
set of SRS parameters, srs-ConfigApDCI-Format0, is
configured by higher layer signalling. For trigger type 1
and DCI formats 1A/2B/2C/2D, a single common set of
SRS parameters, srs-ConfigApDCI-Format1a2b2c, is configured
by higher layer signalling. The SRS request field is 1 bit [4] for
DCI formats 0/1A/2B/2C/2D, with a type 1 SRS triggered if
the value of the SRS request field is set to ‘1’.
A 1-bit SRS request field shall be included in DCI formats
0/1A for frame structure type 1 and 0/1A/2B/2C/2D for frame
structure type 2 if the UE is configured with SRS parameters
for DCI formats 0/1A/2B/2C/2D by higher-layer signalling.

Table 2 below shows an SRS request value for trigger type 1 in DCI format 4 in a 3GPP LTE/LTE-A system.

TABLE 2

| Value of SRS | |
|---|---|
| request field | Description |
| ′00′ | No type 1 SRS trigger |
| ′01′ | The 1^{st} SRS parameter set configured by |
| | higher layers |
| ′10′ | The 2^{nd} SRS parameter set configured |
| | by higher layers |
| ′11′ | The 3^{rd} SRS parameter set configured by |
| | higher layers |

Table 3 belows further describes additions related to SRS transmission in a 3GPP LTE/LTE-A system.

```
TABLE 3
The serving cell specific SRS transmission bandwidths C_{SRS} are configured by higher
layers. The allowable values are given in subclause 5.5.3.2 of [3].
The serving cell specific SRS transmission sub-frames are configured by higher layers.
The allowable values are given in subclause 5.5.3.3 of [3].
For a TDD serving cell, SRS transmissions can occur in UpPTS and uplink subframes
of the UL/DL configuration indicated by the higher layer parameter
subframeAssignment for the serving cell.
When closed-loop UE transmit antenna selection is enabled for a given serving cell for
a UE that supports transmit antenna selection, the index a(n_{SRS}), of the UE antenna that
transmits the SRS at time n_{SRS} is given by
a(n_{SRS}) = n_{SRS} mod 2, for both partial and full sounding bandwidth, and when frequency
hopping is disabled (i.e., bₕₒₚ ≥ B_{SRS}),
$a ( {n}_{SRS} ) = \{ \begin{matrix}( {n}_{SRS} + ⌊ {n}_{SRS} / 2 ⌋ + β \cdot ⌊ {n}_{SRS} / K ⌋ ) mod 2 & when K is even \\ {n}_{SRS} mod 2 & when K is odd\end{matrix} , \\ β = \{ \begin{matrix}1 & where K mod 4 = 0 \\ 0 & otherwise\end{matrix}$
when frequency hopping is enabled (i.e. bₕₒₚ < B_{SRS}),
where values B_{SRS}, bₕₒₚ, N_{b}, and n_{SRS} are given in subclause 5.5.3.2 of [3], and
$K = {\prod }_{{b}^{′} = {b}_{hop}}^{{B}_{SRS}} {N}_{t}$
(where N_{b}_{ₕₒₚ} = 1 regardless of the N_{b} value), except when a single
SRS transmission is configured for the UE. If a UE is configured with more than one
serving cell, the UE is not expected to transmit SRS on different antenna ports
simultaneously.
A UE may be configured to transmit SRS on Np antenna ports of a serving cell where
Np may be configured by higher layer signalling. For PUSCH transmission mode 1
Nₚ ∈ {0, 1, 2, 4} and for PUSCH transmission mode 2 Nₚ ∈ {0, 1, 2} with two antenna
ports configured for PUSCH and Nₚ ∈ {0, 1, 4} with 4 antenna ports configured for
PUSCH. A UE configured for SRS transmission on multiple antenna ports of a serving
cell shall transmit SRS for all the configured transmit antenna ports within one SC-
FDMA symbol of the same subframe of the serving cell.
The SRS transmission bandwidth and starting physical resource block assignment are
the same for all the configured antenna ports of a given serving cell.
A UE not configured with multiple TAGs shall not transmit SRS in a symbol whenever
SRS and PUSCH transmissions happen to overlap in the same symbol.
For TDD serving cell, when one SC-FDMA symbol exists in UpPTS of the given
serving cell, it can be used for SRS transmission. When two SC-FDMA symbols exist
in UpPTS of the given serving cell, both can be used for SRS transmission and for
trigger type 0 SRS both can be assigned to the same UE.
If a UE is not configured with multiple TAGs, or if a UE is configured with multiple
TAGs and SRS and PUCCH format 2/2a/2b happen to coincide in the same subframe in
the same serving cell,
  The UE shall not transmit type 0 triggered SRS whenever type 0 triggered SRS and
PUCCH format 2/2a/2b transmissions happen to coincide in the same subframe;
  The UE shall not transmit type 1 triggered SRS whenever type 1 triggered SRS and
PUCCH format 2a/2b or format 2 with HARQ-ACK transmissions happen to coincide
in the same subframe;
  The UE shall not transmit PUCCH format 2 without HARQ-ACK whenever type 1
triggered SRS and PUCCH format 2 without HARQ-ACK transmissions happen to
coincide in the same subframe.
If a UE is not configured with multiple TAGs, or if a UE is configured with multiple
TAGs and SRS and PUCCH happen to coincide in the same subframe in the same
serving cell,
  The UE shall not transmit SRS whenever SRS transmission and PUCCH
transmission carrying HARQ-ACK and/or positive SR happen to coincide in the same
subframe if the parameter ackNackSRS-SimultaneousTransmission is FALSE;
  For FDD-TDD and primary cell frame structure 1, the UE shall not transmit SRS
in a symbol whenever SRS transmission and PUCCH transmission carrying HARQ-
ACK and/or positive SR using shortened format as defined in subclauses 5.4.1 and
5.4.2A of [3] happen to overlap in the same symbol if the parameter ackNackSRS-
SimultaneousTransmission is TRUE.
  Unless otherwise prohibited, the UE shall transmit SRS whenever SRS
transmission and PUCCH transmission carrying HARQ-ACK and/or positive SR using
shortened format as defined in subclauses 5.4.1 and 5.4.2A of [3] happen to coincide in
the same subframe if the parameter ackNackSRS-SimultaneousTransmission is TRUE.
A UE not configured with multiple TAGs shall not transmit SRS whenever SRS
transmission on any serving cells and PUCCH transmission carrying HARQ-ACK
and/or positive SR using normal PUCCH format as defined in subclauses 5.4.1 and
5.4.2A of [3] happen to coincide in the same subframe.
In UpPTS, whenever SRS transmission instance overlaps with the PRACH region for
preamble format 4 or exceeds the range of uplink system bandwidth configured in the
serving cell, the UE shall not transmit SRS.
The parameter ackNackSRS-SimultaneousTransmission provided by higher layers
determines if a UE is configured to support the transmission of HARQ-ACK on
PUCCH and SRS in one subframe. If it is configured to support the transmission of
HARQ-ACK on PUCCH and SRS in one subframe, then in the cell specific SRS
subframes of the primary cell UE shall transmit HARQ-ACK and SR using the
shortened PUCCH format as defined in subclauses 5.4.1 and 5.4.2A of [3], where the
HARQ-ACK or the SR symbol corresponding to the SRS location is punctured.
This shortened PUCCH format shall be used in a cell specific SRS subframe of the
primary cell even if the UE does not transmit SRS in that subframe. The cell specific
SRS subframes are defined in subclause 5.5.3.3 of [3]. Otherwise, the UE shall use the
normal PUCCH format 1/1a/1b as defined in subclause 5.4.1 of [3] or normal PUCCH
format 3 as defined in subclause 5.4.2A of [3] for the transmission of HARQ-ACK and
SR.
Trigger type 0 SRS configuration of a UE in a serving cell for SRS periodicity, T_{SRS},
and SRS subframe offset, T_{offset}, is defined in Table 8.2-1 and Table 8.2-2, for FDD and
TDD serving cell, respectively. The periodicity T_{SRS} of the SRS transmission is serving
cell specific and is selected from the set {2, 5, 10, 20, 40, 80, 160, 320} ms or
subframes.
For the SRS periodicity T_{SRS} of 2 ms in TDD serving cell, two SRS resources are
configured in a half frame containing UL subframe(s) of the given serving cell.
Type 0 triggered SRS transmission instances in a given serving cell for TDD serving
cell with T_{SRS} > 2 and for FDD serving cell are the subframes satisfying
(10 · n_{f} + k_{SRS} − T_{offset}) mod T_{SRS} = 0, where for FDD k_{SRS} = {0, 1,,,, 0} is the subframe index
within the frame, for TDD serving cell k_{SRS} is defined in Table 8.2-3. The SRS
transmission instances for TDD serving cell with T_{SRS} = 2 are the subframes satisfying
k_{SRS} − T_{offset} .
For TDD serving cell, and a UE configured for type 0 triggered SRS transmission in
serving cell c, and the UE configured with the parameter EIMTA-MainConfigServCell-
r12 for serving cell c, if the UE does not detect an UL/DL configuration indication for
radio frame m (as described in section 13.1), the UE shall not transmit trigger type 0
SRS in a subframe of radio frame m that is indicated by the parameter eimta-
HarqReferenceConfig-r12 as a downlink subframe unless the UE transmits PUSCH in
the same subframe.
Trigger type 1 SRS configuration of a UE in a serving cell for SRS periodicity, T_{SRS,1},
and SRS subframe offset, T_{offset,1}, is defined in Table 8.2-4 and Table 8.2-5, for FDD
and TDD serving cell, respectively. The periodicity T_{SRS,1} of the SRS transmission is
serving cell specific and is selected from the set {2, 5, 10} ms or subframes.
For the SRS periodicity T_{SRS,1} of 2 ms in TDD serving cell, two SRS resources are
configured in a half frame containing UL subframe(s) of the given serving cell.
A UE configured for type 1 triggered SRS transmission in serving cell c and not
configured with a carrier indicator field shall transmit SRS on serving cell c upon
detection of a positive SRS request in PDCCH/EPDCCH scheduling PUSCH/PDSCH
on serving cell c.
A UE configured for type 1 triggered SRS transmission in serving cell c and configured
with a carrier indicator field shall transmit SRS on serving cell c upon detection of a
positive SRS request in PDCCH/EPDCCH scheduling PUSCH/PDSCH with the value
of carrier indicator field corresponding to serving cell c.
A UE configured for type 1 triggered SRS transmission on serving cell c upon detection
of a positive SRS request in subframe n of serving cell c shall commence SRS
transmission in the first subframe satisfying n + k, k ≥ 4 and
  (10 · n_{f} + k_{SRS} − T_{offset,1}) mod T_{SRS,1} = 0 for TDD serving cell c with T_{SRS,1} > 2 and
for FDD serving cell c,
  (k_{SRS} − T_{offset,1}) mod 5 = 0 for TDD serving cell c with T_{SRS,1} = 2
where for FDD serving cell c k_{SRS} = {0, 1, . . . , 9} is the subframe index within the frame
n_{f}, for TDD serving cell c k_{SRS} is defined in Table 8.2-3.
A UE configured for type 1 triggered SRS transmission is not expected to receive type
1 SRS triggering events associated with different values of trigger type 1 SRS
transmission parameters, as configured by higher layer signalling, for the same
subframe and the same serving cell.
For TDD serving cell c, and a UE configured with EIMTA-MainConfigServCell-r12
for a serving cell c, the UE shall not transmit SRS in a subframe of a radio frame that is
indicated by the corresponding eIMTA-UL/DL-configuration as a downlink subframe.
A UE shall not transmit SRS whenever SRS and a PUSCH transmission corresponding
to a Random Access Response Grant or a retransmission of the same transport block as
part of the contention based random access procedure coincide in the same subframe.
```

Table 4 belows a subframe offset T_{offset} and UE-specific SRS periodicity T_{SRS} for trigger type 0 in FDD.

TABLE 4

| SRS Configuration | SRS Periodicity | |
|---|---|---|
| Index I_{SRS} | (ms) | SRS Subframe Offset |
| 0-1 | 2 | I_{SRS} |
| 2-6 | 5 | I_{SRS} - 2 |
| 7-16 | 10 | I_{SRS} - 7 |
| 17-36 | 20 | I_{SRS} - 17 |
| 37-76 | 40 | I_{SRS} - 37 |
| 77-156 | 80 | I_{SRS} - 77 |
| 157-316 | 160 | I_{SRS} - 157 |
| 317-636 | 320 | I_{SRS} - 317 |
| 637-1023 | reserved | reserved |

Table 5 belows a subframe offset T_{offset} and UE-specific SRS periodicity T_{SRS} for trigger type 0 in TDD.

TABLE 5

| SRS Configuration | SRS Periodicity | |
|---|---|---|
| Index I_{SRS} | (ms) | SRS Subframe Offset |
| 0-1 | 2 | I_{SRS} |
| 2-6 | 5 | I_{SRS} - 2 |
| 7-16 | 10 | I_{SRS} - 7 |
| 17-36 | 20 | I_{SRS} - 17 |
| 37-76 | 40 | I_{SRS} - 37 |
| 77-156 | 80 | I_{SRS} - 77 |
| 157-316 | 160 | I_{SRS} - 157 |
| 317-636 | 320 | I_{SRS} - 317 |
| 637-1023 | reserved | reserved |

TABLE 6

| SRS | | |
|---|---|---|
| Configuration | SRS | SRS |
| Index | Periodicity | Subframe |
| I_{SRS} | (ms) | Offset |
| 0 | 2 | 0, 1 |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS} - 10 |
| 15-24 | 10 | I_{SRS} - 15 |
| 25-44 | 20 | I_{SRS} - 25 |
| 45-84 | 40 | I_{SRS} - 45 |
| 85-164 | 80 | I_{SRS} - 85 |
| 165-324 | 160 | I_{SRS} - 165 |
| 325-644 | 320 | I_{SRS} - 325 |
| 645-1023 | reserved | reserved |

Table 7 shows kSRS for TDD.

TABLE 7

| | subframe index n | | | | | | | | | | | |
|---|---|---|---|---|---|---|---|---|---|---|---|---|
| | | 1 | | | | | | 6 | | | | |
| | | 1st | 2nd | | | | | 1st | 2nd | | | |
| | | symbol | symbol | | | | | symbol | symbol | | | |
| | | of | of | | | | | of | of | | | |
| | 0 | UpPTS | UpPTS | 2 | 3 | 4 | 5 | UpPTS | UpPTS | 7 | 8 | 9 |
| k_{SRS} in case | | 0 | 1 | 2 | 3 | 4 | | 5 | 6 | 7 | 8 | 9 |
| UpPTS length | | | | | | | | | | | | |
| of 2 symbols | | | | | | | | | | | | |
| k_{SRS} in case | | 1 | | 2 | 3 | 4 | | 6 | | 7 | 8 | 9 |
| UpPTS length | | | | | | | | | | | | |
| of 1 symbol | | | | | | | | | | | | |

Table 8 belows a subframe offset T_{offset,1} and UE-specific SRS periodicity T_{SRS,1} for trigger type 1 in FDD.

TABLE 8

| | SRS | |
|---|---|---|
| SRS Configuration | Periodicity | SRS Subframe |
| Index I_{SRS} | (ms) | Offset |
| 0-1 | 2 | I_{SRS} |
| 2-6 | 5 | I_{SRS} - 2 |
| 7-16 | 10 | I_{SRS} - 7 |
| 17-31 | reserved | reserved |

Table 9 belows a subframe offset T_{offset,1} and UE-specific SRS periodicity T_{SRS,1} for trigger type 1 in TDD.

TABLE 9

| | SRS | |
|---|---|---|
| SRS Configuration | Periodicity | SRS Subframe |
| Index I_{SRS} | (ms) | Offset |
| 0 | reserved | reserved |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS} - 10 |
| 15-24 | 10 | I_{SRS} - 15 |
| 25-31 | reserved | reserved |

Table 10 below shows details of Cell ID and root values in the LTE system. In the NR system, Cell ID and root values can be determined based on the details of Table 10 below.

TABLE 10
The sequence-group u in slot nₛ is defined by a group hopping pattern f_{gh} (nₛ) and a
sequence-shift pattern fₛₛ, according to
u = (f_{gh} (nₛ) + fₛₛ)mod30
There are 17 different hopping patterns and 30 different sequence-shift patterns. Sequence-
group hopping can be enabled or disabled by means of the cell-specific parameter Group-
hopping-enabled provided by higher layers. Sequence-group hopping for PUSCH can be
disabled for a certain UE through the higher-layer parameter Disable-sequence-group-
hopping despite being enabled on a cell basis unless the PUSCH transmission corresponds to
a Random Access Response Grant or a retransmission of the same transport block as part of
the contention based random access procedure.
The group-hopping pattern f_{gh} (nₛ) may be different for PUSCH, PUCCH and SRS and is
given by
${f}_{gh} ( {n}_{s} ) = \{ \begin{matrix}0 & if group hopping is disabled \\ ( {\sum }_{i = 0}^{7} c ( 8 {n}_{s} + i ) \cdot {2}^{i} ) mod 30 & if group hopping is enabled\end{matrix}$
where the pseudo-random sequence c(i) is defined by clause 7.2. The pseudo-random
sequence generator shall be initialized with
${c}_{init} = ⌊ \frac{{n}_{ID}^{RS}}{30} ⌋ at the beginning of each radio frame where {n}_{ID }^{RS} is given by clause 5.5 .1 .5 .$
The sequence-shift pattern fₛₛ definition differs between PUCCH, PUSCH and SRS.
For SRS, the sequence-shift pattern fₛₛ^{SRS} is given by fₛₛ^{SRS} = n_{ID}^{RS} mod 30 where n_{ID}^{RS} is given
by clause 5.5.1.5.
Sequence hopping only applies for reference-signals of length M_{sc}^{RS} ≥ 6_{sc}^{RB}.
For reference-signals of length M_{sc}^{RS} < 6_{sc}^{RB}, the base sequence number v within the base
sequence group is given by v = 0.
For reference-signals of length M_{sc}^{RS} ≥ 6N_{sc}^{RB}, the base sequence number v within the base
sequence group in slot nₛ is defined by
$v = \{ \begin{matrix}c ( {n}_{s} ) & if group hopping is disabled and sequence hopping is enabled \\ 0 & otherwise\end{matrix}$
where the pseudo-random sequence c(i) is given by clause 7.2. The parameter Sequence-
hopping-enabled provided by higher layers determines if sequence hopping is enabled or
not. Sequence hopping for PUSCH can be disabled for a certain UE through the higher-
layer parameter Disable-sequence-group-hopping despite being enabled on a cell basis
unless the PUSCH transmission corresponds to a Random Access Response Grant or a
retransmission of the same transport block as part of the contention based random access
procedure.
For SRS, the pseudo-random sequence generator shall be initialized with
${c}_{init} = ⌊ \frac{{n}_{ID}^{RS}}{30} ⌋ \cdot {2}^{5} + ( {n}_{ID}^{RS} + {Δ}_{ss} ) mod 30 at the beginning of each radio frame when {n}_{ID}^{RS}$
is given by clause 5.5.1.5 and Δₛₛ is given by clause 5.5.1.3.
Sounding reference signals: n_{ID}^{RS} = N_{ID}^{cell}.
${x}_{q} ( m ) = {e}^{- j \frac{π q m ( m + 1 )}{{N}_{ZC}^{RS}}} , 0 \leq m \leq {N}_{ZC}^{RS} - 1$
with q given by
q = └q̅ + 1/2┘ + v · (−1)^{└2}^̅{̅q̅}̅┘
q̅ = N_{ZC}^{RS} · (u + 1)/31

Analog Beamforming

In a Millimeter Wave (mmW) system, since a wavelength is short, a plurality of antennas can be installed in the same area. That is, considering that the wavelength in the 30 GHz band is 1 cm, a total of 64 (8×8) antenna elements can be installed in a 4 cm by 4 cm panel at intervals of 0.5 lambda (wavelength) in the case of a 2-dimensional array. Therefore, in the mmW system, it is attempted to improve the coverage or throughput by increasing the beamforming (BF) gain using multiple antenna elements.

In this case, if each antenna element includes a transceiver unit (TXRU) to enable adjustment of transmit power and phase per antenna element, each antenna element can perform independent beamforming per frequency resource. However, installing TXRUs in all of the about 100 antenna elements is less feasible in terms of cost. Therefore, a method of mapping a plurality of antenna elements to one TXRU and adjusting the direction of a beam using an analog phase shifter has been considered. However, such an analog beamforming method is disadvantageous in that frequency selective beaming is impossible because only one beam direction is generated over the full band.

As an intermediate form of digital BF and analog BF, hybrid BF with B TXRUs that are fewer than Q antenna elements can be considered. In the case of the hybrid BF, the number of beam directions that can be transmitted at the same time is limited to B or less, which depends on how B TXRUs and Q antenna elements are connected.

FIG. 2a is a view showing TXRU virtualization model option 1 (sub-array model) and FIG. 2b is a view showing TXRU virtualization model option 2 (full connection model).

FIGS. 2a and 2b show representative examples of a method of connecting TXRUs and antenna elements. Here, the TXRU virtualization model shows a relationship between TXRU output signals and antenna element output signals. FIG. 2a shows a method of connecting TXRUs to sub-arrays. In this case, one antenna element is connected to one TXRU. In contrast, FIG. 2b shows a method of connecting all TXRUs to all antenna elements. In this case, all antenna elements are connected to all TXRUs. In FIGS. 2a and 2b, W indicates a phase vector weighted by an analog phase shifter. That is, W is a major parameter determining the direction of the analog beamforming. In this case, the mapping relationship between CSI-RS antenna ports and TXRUs may be 1-to-1 or 1-to-many.

Hybrid Beamforming

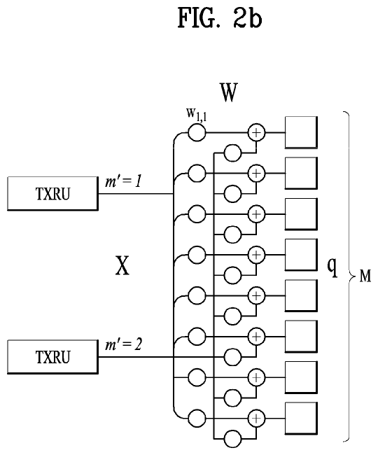

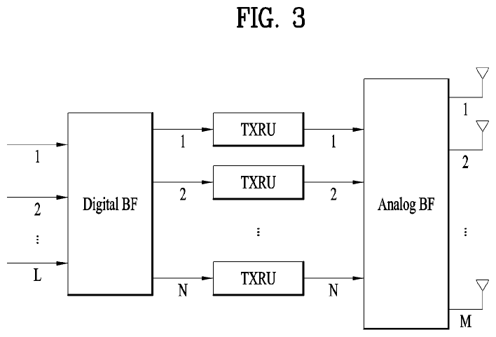

FIG. 3 is a block diagram for hybrid beamforming.

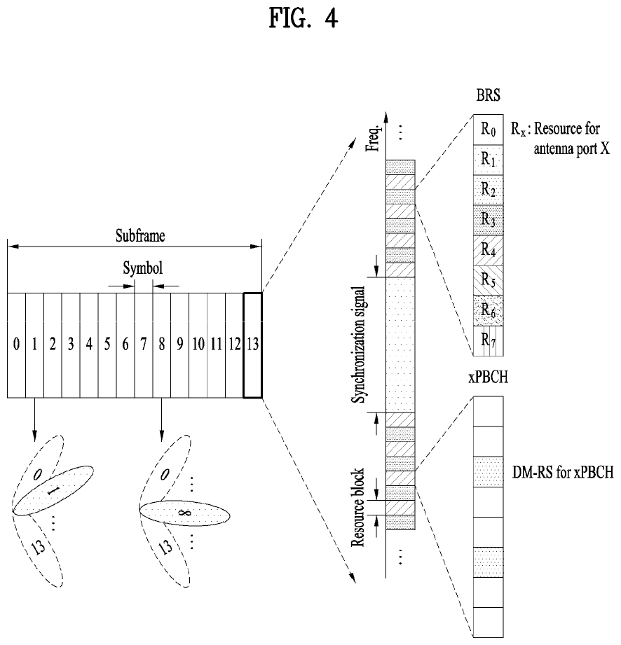

If a plurality of antennas is used in a new RAT system, a hybrid beamforming scheme which is a combination of digital beamforming and analog beamforming may be used. At this time, analog beamforming (or RF beamforming) means operation of performing precoding (or combining) at an RF stage. In the hybrid beamforming scheme, each of a baseband stage and an RF stage uses a precoding (or combining) method, thereby reducing the number of RF chains and the number of D/A (or A/D) converters and obtaining performance similar to performance of digital beamforming. For convenience of description, as shown in FIG. 4, the hybrid beamforming structure may be expressed by N transceivers (TXRUs) and M physical antennas. Digital beamforming for L data layers to be transmitted by a transmission side may be expressed by an N×L matrix, N digital signals are converted into analog signals through TXRUs and then analog beamforming expressed by an M×N matrix is applied.

FIG. 3 shows a hybrid beamforming structure in terms of the TXRUs and physical antennas. At this time, in FIG. 3, the number of digital beams is L and the number of analog beams is N. Further, in the new RAT system, a BS is designed to change analog beamforming in symbol units, thereby supporting more efficient beamforming for a UE located in a specific region. Furthermore, in FIG. 3, when N TXRUs and M RF antennas are defined as one antenna panel, up to a method of introducing a plurality of antenna panels, to which independent hybrid beamforming is applicable, is being considered in the new RAT system.

When the BS uses a plurality of analog beams, since an analog beam which is advantageous for signal reception may differ between UEs, the BS may consider beam sweeping operation in which the plurality of analog beams, which will be applied by the BS in a specific subframe (SF), is changed according to symbol with respect to at least synchronization signals, system information, paging, etc. such that all UEs have reception opportunities.

FIG. 4 is a view showing an example of beams mapped to BRS symbols in hybrid beamforming.

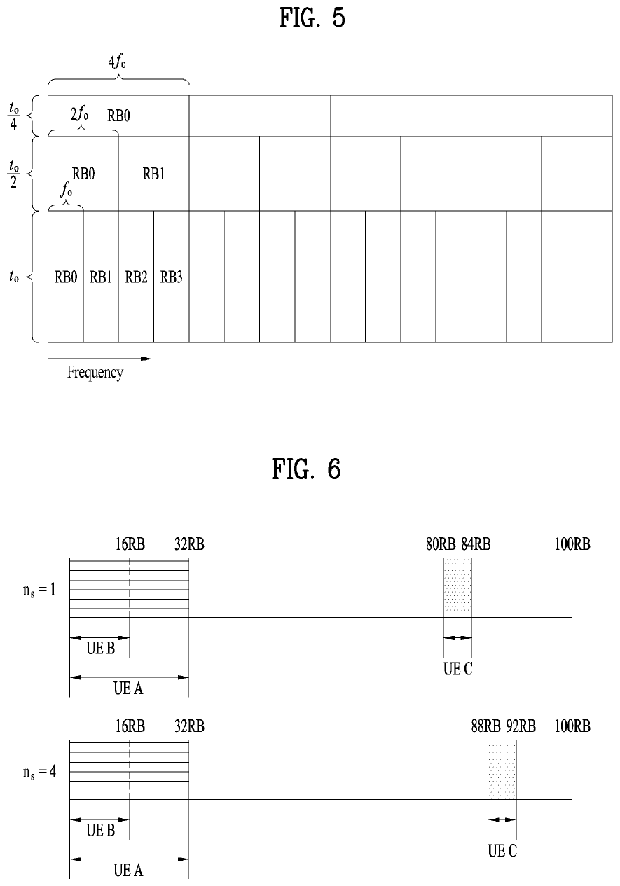

FIG. 4 shows the beam sweeping operation with respect to synchronization signals and system information in a downlink (DL) transmission procedure. In FIG. 4, a physical resource (or physical channel) through which the system information of the new RAT system is transmitted in a broadcast manner is named xPBCH (physical broadcast channel). At this time, analog beams belonging to different antenna panels may be simultaneously transmitted within one symbol, and, in order to measure a channel per analog beam, as shown in FIG. 4, a method of introducing a beam reference signal (BRS) which is an RS transmitted by applying a single analog beam (corresponding to a specific analog panel) may be considered. The BRS may be defined with respect to a plurality of antenna ports and each antenna port of the BRS may correspond to a single analog beam. Although the RS used to measure the beam is given BRS in FIG. 5, the RS used to measure the beam may be named another name. At this time, unlike the BRS, a synchronization signal or xPBCH may be transmitted by applying all analog beams of an analog beam group, such that an arbitrary UE properly receives the synchronization signal or xPBCH.

FIG. 5 is a view showing symbol/sub-symbol alignment between different numerologies.

New RAT(NR) numerology characteristics

In NR, a method of supporting scalable numerology is being considered. That is, a subcarrier spacing of NR is (2n×15) kHz and n is an integer. From the nested viewpoint, a subset or a superset (at least 15, 30, 60, 120, 240, and 480 kHz) is being considered as a main subcarrier spacing. Symbol or sub-symbol alignment between different numerologies was supported by performing control to have the same CP overhead ratio.

In addition, numerology is determined in a structure for dynamically allocating time/frequency granularity according to services (eMMB, URLLC and mMTC) and scenarios (high speed, etc.).

SRS hopping characteristics in the LTE system are as follows.
SRS hopping operation is performed only at the time of periodic SRS triggering (triggering type 0).
Allocation of SRS resources is given in a predefined hopping pattern.
A hopping pattern may be configured through RRC signaling in a UE-specific manner (however, overlapping is not allowed).
The SRSs may be frequency-hopped and transmitted using a hopping pattern for each subframe in which a cell/UE-specific SRS is transmitted.
The SRS frequency-domain start position and hopping equation are analyzed through Equation 1 below.

$${k}_{0}^{( p )} = {\overline{k}}_{0}^{( p )} + {\sum }_{b = 0}^{{B}_{SRS}} {K}_{TC} {M}_{sc , b}^{RS} {n}_{b} \\ {n}_{b} = \{ \begin{matrix}⌊ 4 {n}_{RRC} / {m}_{SRS , b} ⌋ mod {N}_{b} & b \leq {b}_{hop} \\ \{ \begin{matrix}{F}_{b} ( {n}_{SRS} ) + \\ ⌊ 4 {n}_{RRC} / {m}_{SRS , b} ⌋\end{matrix} \} mod {N}_{b} & otherwise\end{matrix} \\ {F}_{b} ( {n}_{SRS} ) = \{ \begin{matrix}\begin{matrix}( {N}_{b} / 2 ) ⌊ \frac{{n}_{SRS} mod {Π}_{{b}^{′} = {b}_{hop}}^{b} {N}_{{b}^{′}}}{{Π}_{{b}^{′} = {b}_{hop}}^{b} {N}_{{b}^{′}}} ⌋ + \\ ⌊ \frac{{n}_{SRS} mod {Π}_{{b}^{′} = {b}_{hop}}^{b} {N}_{{b}^{′}}}{2 {Π}_{{b}^{′} = {b}_{hop}}^{b - 1} {N}_{{b}^{′}}} ⌋\end{matrix} & if {N}_{b} even \\ ⌊ {N}_{b} / 2 ⌋ ⌊ {n}_{SRS} / {Π}_{{b}^{′} = {b}_{hop}}^{b - 1} {N}_{{b}^{′}} ⌋ & if {N}_{b} odd\end{matrix} \\ {n}_{SRS} = \{ \begin{matrix}\begin{matrix}2 {N}_{SP} {n}_{f} + 2 ( {N}_{SP} - 1 ) \\ ⌊ \frac{{n}_{s}}{10} ⌋ + ⌊ \frac{{T}_{offset}}{{T}_{offset \_ max}} ⌋ ,\end{matrix} & \begin{matrix}for 2 ms SRS periodicity of \\ frame structure type 2\end{matrix} \\ ⌊ ( {n}_{f} \times 10 + ⌊ {n}_{s} / 2 ⌋ ) / {T}_{SRS} ⌋ , & otherwise\end{matrix} \qquad [ Equation 1 ]$$

where, n_{SRS} denotes a hopping interval in the time domain, Nb denotes the number of branches allocated to a tree level b, and b may be determined by setting B_{SRS} in dedicated RRC.

FIG. 6 is a view showing an LTE hopping pattern (nₛ=1-->nₛ=4).

An example of configuring an LTE hopping pattern will be described.

LTE hopping pattern parameters may be set through cell-specific RRC signaling. For example, C_{SRS}=, N_{RB}^{UL}=1; n_{f}=1, nₛ=1 may be set.

Next, LTE hopping pattern parameters may be set through UE-specific RRC
UE A: B_{SRS}=1, bₕₒₚ=0, n_{RRC}=22, T_{SRS}=10
UE B: B_{SRS}=2, bₕₒₚ=0, n_{RRC}=10, T_{SRS}=5 signaling. For example, UE C: B_{SRS}=3, bₕₒₚ=, n_{RRC}=23, T_{SRS}=2 may be set.

Table 11 below describes available options to avoid collision between an SRS transmission and a PUSCH transmission in NR.

```
TABLE 11
  From a UE perspective, NR supports one or both of the following
options on a given carrier:
    Option 1 : Support only one of the following options for avoiding
  collisions between NR-SRS and short PUCCH
      Option 1-1 : symbol level TDM
      Option 1-2 : FDM
      Option 1-3 : both symbol level TDM and FDM
      FFS : details
      Note: other options are not precluded
    Option 2: Prioritize SRS or short PUCCH transmission, i.e., drop SRS
  or short PUCCH in case of collision
      FFS whether to have one prioritization rule, or configurable
    prioritization
```

In NR, various configurations may be available for an SRS according to periodic, aperiodic, or semi-persistent scheduling. Depending on the usage (e.g., UL CSI acquisition, UL beam management, or the like) of an SRS transmission, SRS resource allocation and antenna port mapping may be performed differently. Further, for an SRS transmission, one, two, or four consecutive symbols may be allocated dynamically and frequency hopping may be applied at a symbol level or slot level. Although this SRS configuration should be performed such that an SRS resource allocation area does not collide with a PUCCH allocation resource, there are too many SRS configurations to reserve PUCCH resources. Each time a PUCCH is allocated, the PUCCH needs to avoid an SRS symbol position in the case of time division multiplexing (TDM), and an SRS hopping pattern in the case of frequency division multiplexing. Because a periodic SRS generally hops in a pattern according to symbol or slot indexes, the PUCCH may also be allocated based on this pattern. Accordingly, a BS may allocate the PUCCH without resource limitations caused by SRS allocation, when needed.

Table 12 below lists PUCCH formats in NR.

TABLE 12

| | Length | | |
|---|---|---|---|
| Format | of | Number | |
| Types | Symbols | of bits | Descriptions (based on 38.300-5.3.3) |
| Format | 1~2 | <=2 | Short PUCCH. |
| 0 | | | with UE multiplexing in the same PRB. |
| | | | Based on sequence selection. |
| Format | 4~14 | <=2 | Long PUCCH. |
| 1 | | | with multiplexing in the same PRB. |
| | | | time-multiplex the UCI and DMRS |
| Format | 1~2 | >2 | Short PUCCH. |
| 2 | | | with no multiplexing in the same PRB. |
| | | | frequency multiplexes UCI and DMRS |
| Format | 4~14 | >2 | Long PUCCH. |
| 3 | | | with moderate UCI payloads and with some |
| | | | multiplexing capacity in the same PRB. |
| | | | time-multiplex the UCI and DMRS |
| Format | 4~14 | >2 | Long PUCCH. |
| 4 | | | with large UCI payloads and with |
| | | | no multiplexing capacity in the same PRB |

As noted from Table 12, an ACK/NACK, channel state information (CSI), a scheduling request (SR), or the like may be included as UCI in a (periodic) PUCCH.

Proposal 1

For an SRS and a short/long PUCCH (e.g., an ACK/NACK or an SR) which are multiplexed in FDM in the time/frequency domain, the BS may allocate the SRS and the short/long PUCCH in frequency hopping patterns. The SRS and the short/long PUCCH may hop in frequency across symbols, slots, mini-slots, subframes, or the like.
An SRS area and a short/long PUCCH area may also be allocated in FDM in independent frequency hopping patterns across symbols, slots, min-slots, or subframes.
When a UL time/frequency area is reserved for the SRS (e.g., periodic SRS or semi-persistent SRS) and the short/long PUCCH is allocated in FDM with the SRS in the UL time/frequency area, the short/long PUCCH is allocated in a resource area to which the SRS is not allocated, in consideration of the SRS hopping pattern. The resource area of the short/long PUCCH may be allocated in conjunction with the SRS hopping pattern.

When a UL time/frequency area is reserved for the short/long PUCCH (e.g., periodic PUCCH) and the SRS is allocated in FDM with the short/long PUCCH in the UL time/frequency area, the SRS is allocated in a resource area to which the short/long PUCCH is not allocated, in consideration of the short/long PUCCH hopping pattern. The resource area of the SRS may be allocated in conjunction with the short/long PUCCH hopping pattern.

FIG. 7 is a diagram illustrating multiplexing between an SRS and a PUCCH (symbol-level hopping) according to Embodiment 1 of Proposal 1.

FIG. 7 illustrates resource allocation areas based on an SRS pattern and a PUCCH area multiplexed in FDM with SRSs. Two symbols are configured for SRS and PUCCH transmissions. In this configuration, areas in which three UEs UE A, UE B, and UE C transmit SRSs are shown in FIG. 7. In FIG. 7, SRSs and a PUCCH hop in frequency at a symbol level.

Referring to FIG. 7, in a total frequency resource area K, the SRS transmission areas are configured in a frequency resource area spanning from k₀+k₀′ to k₀+k₁′ in symbol l₁, and in a frequency resource area spanning from k₀ to k₀+k₀″ in symbol l₂. Therefore, since there are values of F(n_{PUCCH}) and F_{b}(n_{SRS}) indicating the position of an SRS configuration (or allocation) area, the resource allocations may be distinguished from each other. n_{SRS} may represent the timing index of an SRS transmission symbol, slot, or mini-slot, and n_{PUCCH} may represent the timing index of a PUCCH transmission symbol or slot.

Each of n_{SRS} and n_{PUCCH} may be represented by a function of n_{f}, nₛ, n_{m_s}, and n_{symbol} (n_{f}, nₛ, n_{m_s}, and n_{symbol} may represent a frame index, a slot index, a mini-slot index, and a symbol index, respectively). F_{b}(n_{SRS}) and F(n_{PUCCH}) may represent the starting positions of resource allocations (e.g., the starting frequency positions of resource allocations) based on an SRS hopping pattern and a PUCCH hopping pattern. Accordingly, the position of an SRS transmission (frequency) area may be represented as k₀+F_{b} (n_{SRS}) in both of symbol l₁, and symbol l₂. The PUCCH transmission area may be represented as k₀+F(n_{PUCCH}) in both of symbol l₁, and symbol l₂.

In Embodiment 2 of Proposal 1, a PUCCH resource area may be reserved in an SRS transmission area, and a PUCCH may hop in frequency and may be transmitted in FDM with an SRS (e.g., 2-symbol SRSs, a 2-symbol PUCCH, and SRS transmissions from three UEs in FIG. 7). The value of F(n_{PUCCH}) is determined according to a symbol, slot, mini-slot, or subframe carrying the PUCCH. In the above example, F(n_{PUCCH})=k₀ in symbol l₁, and F(n_{PUCCH})=k₁″ in symbol l₂. When the SRSs are triggered in a corresponding symbol, F_{b}(n_{SRS},F(n_{PUCCH})) may be given in consideration of F(n_{PUCCH})=k₀ in symbol l₁ in which the SRSs are transmitted (or allocated) only in a frequency area spanning from k₀′ to k₁′, whereas F_{b}(n_{SRS},F(n_{PUCCH})) may be given in consideration of F(n_{PUCCH})=k₁″ in symbol l₂ in which the SRSs are transmitted (or allocated) only in a frequency area spanning from k₀″ to k₁″. This SRS area does not overlap with frequency resources to which the PUCCH is allocated.

In Embodiment 3 of Proposal 1, when a SRS transmission area is pre-reserved (e.g., in the case of periodic SRS triggering) and a PUCCH is multiplexed with an SRS in the SRS transmission area, frequency hopping may occur, as illustrated in FIG. 7. The value of F(n_{SRS}) is determined according to a symbol, slot, mini-slot, or subframe carrying the SRS. In the above example, F(n_{SRS})=k₀ in symbol l₁ and F(n_{PUCCH})=k₁″ in symbol l₂. When the SRS is triggered in a corresponding symbol, F_{b}(n_{SRS},F(n_{PUCCH})) may be given in consideration of F(n_{PUCCH})=k₀ in symbol l₁ in which the SRS is transmitted only in the frequency area spanning from k₀′ to k₁′, whereas F_{b}(n_{SRS},F(n_{PUCCH})) may be given in consideration of F(n_{PUCCH})=k₁″ in symbol l₂ in which the SRS is transmitted or allocated only in the frequency area spanning from k₀″ to k₁″.

Proposal 2

Either or both of the size and position of the resource area of a short/long PUCCH multiplexed with an SRS in FDM may be configured by a higher layer. That is, information about the size and/or position of the resource area of the short/long PUCCH multiplexed with the SRS in FDM may be transmitted to a UE by higher-layer signaling from a BS. A set of candidates for the size and position of the resource area of the short/long PUCCH are given, each candidate having a short/long PUCCH frequency hopping pattern. Information about PUCCH frequency hopping may also be configured by the higher layer. The index of the PUCCH candidate set may be transmitted to the UE by downlink control information (DCI) or higher-layer signaling from the BS.

In Embodiment 1 of Proposal 2, sets of sizes, positions, and frequency hopping pattern information for a PUCCH resource area are proposed. Table 12 below lists exemplary sets of sizes, position, and frequency hopping pattern information for a PUCCH resource area. Table 13 may be shared between and thus known to the BS and the UE.

TABLE 13

| PUCCH | | | (Frequency) hopping |
|---|---|---|---|
| candidate | PUCCH size | | pattern function of |
| set | (PRB group) | PUCCH position | each candidate |
| 0 | PRG = 1 | k₀ + F₁(n_{PUCCH}) | F₁(n_{PUCCH}) |
| 1 | PRG = 2 | k₀ + F₂(n_{PUCCH}) | F₂(n_{PUCCH}) |
| 2 | PRG = 3 | k₀ + F₃(n_{PUCCH}) | F₃(n_{PUCCH}) |

For example, when the BS transmits PUCCH candidate set index ‘0’ to the UE by DCI or higher-layer signaling (e.g., RRC signaling), the UE may identify that the PUCCH size (PRB group) is PRG=1, the PUCCH position is k₀+F₁(n_{PUCCH}), and the (frequency) hopping pattern function for each PUCCH candidate is F₁(n_{PUCCH}).

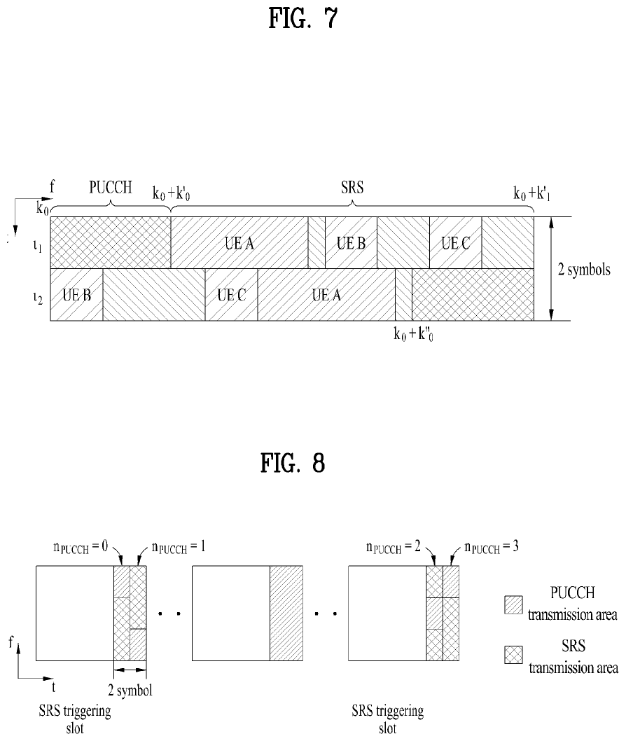

FIG. 8 is a diagram illustrating an exemplary PUCCH hopping pattern.

In Embodiment 2 of Proposal 2, it is proposed that a frequency hopping pattern is applied to a PUCCH, when the PUCCH is multiplexed with an SRS.

As illustrated in FIG. 8, a hopping pattern for candidates for each PUCCH transmission (or allocation) area may be determined according to symbols, slots, mini-slots, or subframes of a PUCCH multiplexed with an SRS. The positions of the PUCCH hopping pattern may be determined according to n_{PUCCH}. When the PUCCH is allocated to the index of a symbol, slot, min-slot, or subframe in which the PUCCH is multiplexed with the SRS in FDM, n_{PUCCH} may change, which in turn changes a PUCCH hopping pattern function F₁(n_{PUCCH}). Thus, the PUCCH may be transmitted in FDM with the SRS, frequency-hopped with the SRS.

Proposal 3

To allocate an aperiodic short/long PUCCH in an SRS transmission area spanning multi-symbols, slots, and/or min-slots, available short/long PUCCH candidates are mapped to resource areas other than the SRS transmission area according to an SRS hopping pattern.
When the SRS is transmitted across a total UL bandwidth part (BWP), areas other than an SRS resource area in the total UL BWP, K (e.g., K/{m_{SRS1},m_{SRS2}, m_{SRS3}, . . . , m_{SRS_A}} where m_{SRS_α} is an SRS resource allocation area for UE α) are available for resource allocation of the short/long PUCCH. Herein, a short/long PUCCH allocation index may be predetermined or determined explicitly.
The BS may provide aperiodic short/long PUCCH allocation candidate indexes to the UE by DCI or higher-layer signaling (e.g., RRC signaling), for allocating the aperiodic short/long PUCCH in the SRS resource area.
Information about a PUCCH candidate set may include a PUCCH allocation candidate index. Table 14 below lists exemplary information about PUCCH candidate sets each including a PUCCH allocation candidate index. Table 14 may be shared between and thus known to the BS and the UE.

TABLE 14

| PUCCH | | |
|---|---|---|
| candidate | PUCCH size | |
| set | (PRB group) | PUCCH position |
| 0 | PRG = 1 | PUCCH allocation candidate index |
| | | 0 |
| 1 | PRG = 2 | PUCCH allocation candidate index |
| | | 1 |
| 2 | PRG = 3 | PUCCH allocation candidate index |
| | | 2 |

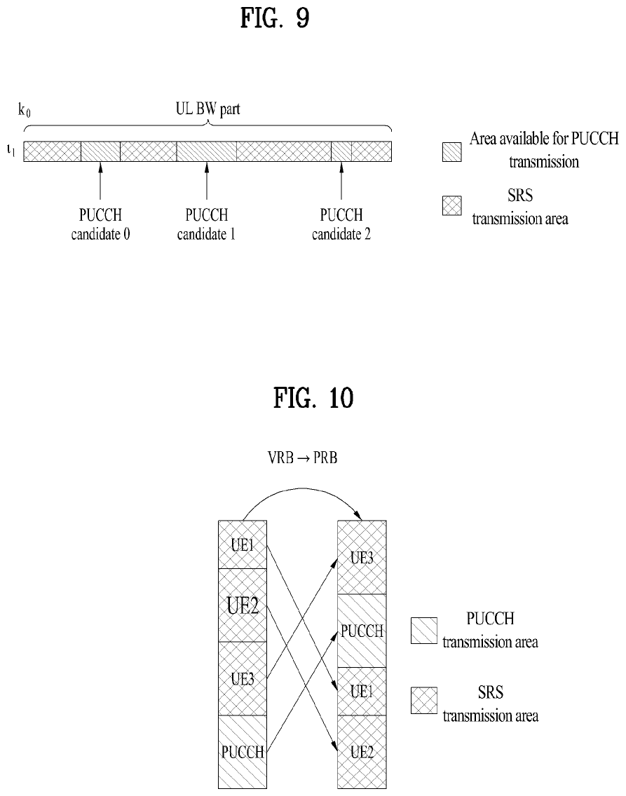

FIG. 9 is a diagram illustrating exemplary application of PUCCH candidate position indexes in an embodiment of Proposal 3. Particularly, the indexes of aperiodic PUCCH allocation position candidates are determined in the example of FIG. 9.

When SRSs are distributed across a total UL BWP and areas are available for allocation to a PUCCH in symbol l₁ as illustrated in FIG. 9, PUCCH candidates may be determined based on k₀. The PUCCH candidates may be determined as agreed between the BS and the UE, for example, in an ascending or descending order of k₀, or explicitly indicated to the UE by a higher layer. In the latter case, the PUCCH candidates may be indicated by indexes based on k₀. Table 15 illustrates exemplary indexing rules for indexing available PUCCH candidates (the number of PUCCH candidates=3). Table 15 may be shared between the BS and the UE and thus known to the BS and the UE.

TABLE 15

| PUCCH (allocation) | |
|---|---|
| candidate index | Indexing rule |
| 0 | {1, 2, 3} |
| 1 | {2, 1, 3} |
| 2 | {3, 2, 1} |

For example, when PUCCH (allocation) candidate index 0 of Table 15 is transmitted cell-specifically (e.g., by cell-specific RRC signaling), areas other than SRS transmission areas are determined to be PUCCH candidates, which are indexed with PUCCH candidate indexes 1, 2 and 3 from k₀, as illustrated in FIG. 9. The BS may provide the UE with one of the PUCCH candidate sets for PUCCH allocation.

Proposal 4

In a symbol, slot, or mini-slot in which an SRS is configured, a PUCCH resource area is allocated in virtual physical resource blocks (VPRBs), and the VPRBs are mapped to physical resource blocks (PRBs) in an area other than an SRS resource allocation area to which frequency hopping is allocated. That is, the SRS and a short/long PUCCH are multiplexed in FDM in the VPRBs, and also in the PRBs by a function of converting VPRBs to PRBs. The indexes of VPRBs may be resource units that distinguish the resources of the VPRBs from each other.
PUCCH VPRB-PRB mapping function:

The function may be a function of the index of a slot, symbol, mini-slot, subframe, and/or radio frame, which may be expressed as, for example, f_{PUCCH}(VPRB_{index}, n_{PUCCH} The function may be an operating function based on a PUCCH triggering counter, which may be expressed as, for example, f_{PUCCH}(VPRB_{index},j) where j is a PUCCH triggering counter value. Alternatively, the function may be predetermined, for example, f_{PUCCH}(VPRB_{index}) Alternatively, the function may be a counterpart to an SRS hopping pattern, which may be given as

$${f}_{PUCCH} ( {VPRB}_{index} ) = arg \{ x \vert {x}^{c} ∈ {A}_{SRS} \}$$

where A_{SRS} is an SRS resource allocation area.

The PUCCH VPRB-PRB mapping function may provide freedom for a PUCCH resource allocation area, which may be given by a function of converting a VPRB to a PRB according to a virtual resource index in a specific symbol. The PUCCH VPRB-PRB mapping function operates in conjunction with an SRS frequency hopping pattern. The PUCCH is designed to be mapped to a frequency resource area to which the SRS is not allocated.

FIG. 10 is a diagram illustrating an exemplary method of allocating VRBs to an SRS and a PUCCH and then mapping the VRBs to PRBs, when the SRS and the PUCCH are multiplexed.

FIG. 10 illustrates an exemplary VPRB-PRB mapping rule which uses a PUCCH symbol index.

When a PUCCH transmission is performed in the last symbol of each slot, a PUCCH transmisison symbol index may be defined by the following equation.

n_{PUCCH}=└nₛ┘ [Equation 2]

It is assumed that in the presence of any PUCCH multiplexed with an SRS, a resource for the PUCCH to be multiplexed is mapped to VPRB index 4. When

$${f}_{PUCCH} ( {VPRB}_{index} , {n}_{PUCCH} ) = \frac{BW * ( ( {VPRB}_{index} + {n}_{PUCCH} ) mod 5 )}{5}$$

(where BW represents the size of a bandwidth), a value of PRB is mapped to 0 in PUCCH transmission symbol index 1, and a value of PRB is mapped to

$$\frac{BW}{5}$$

in PUCCH transmission symbol index 2.

Proposal 5

When a short/long PUCCH is allocated in an area to which an SRS is allocated, the short/long PUCCH may be transmited in an unused code division multiplexing (CDM) (e.g., cyclic shift (CS)) SRS resource. The following CDM cases are given.
When the number of ports allocated to a specific UE in the same SRS resource is less than a maximum available CDM capability (e.g., the maximum number of available CSs in the SRS resource), the UE may perform corresponding port mapping by using other CDM codes (e.g., other CSs), while using the remaining CDM codes (e.g., the remaining CSs) for a PUCCH transmission.
For an SRS used for UL beam managment, only one or two ports are mapped to one SRS resource. However, the above operation may not be performed for UL or DL assistant beam searching.
For a UE which has to perform SRS switching according to a radio frequency (RF) capability, the number of ports transmittable in SRS resources transmitted for UL CSI acquisition is limited, and thus the remaining CSs may be utilized. In this case, the remaining CSs may be used for a PUCCH transmission.

Proposal 5-1

The BS may transmit an indicator (e.g., flag) for applying CDM with a short/long PUCCH in specific SRS resources to the UE by DCI, cell-specific higher-layer signaing, or UE-specific higher-layer signaling. The indicator (e.g., flag) may include the following information.
The BS may transmit a flag indicating whether an SRS may be multiplexed with a PUCCH in CDM, when providing informaiton about target SRS resources. The BS may transmit a short PUCCH (ACK/NACK or SR) tranmission indication by an SRS resource indicator (SRI). Therefore, the UE may transmit the PUCCH by multiplexing the PUCCH in CDM with SRS resources indicated by the SRI (e.g., by applying a CS). The BS may indicate a CS value to be used for the PUCCH transmission in the SRS resources. When the BS matches a time/frequency area in which the PUCCH is transmitted with a resource area in which the SRS is transmitted, the UE multiplexes the PUCCH with the SRS in CDM in the SRS resources.

Proposal 6

When an SRS is multiplexed with a short/long PUCCH in TDM, the resource allocation areas of the SRS and the short/long PUCCH may change according to their priorities of using a symbol.
Case 1: In the case where the transmission area of a periodic short/long PUCCH is reserved and an aperiodic SRS is allocated across multiple symbols, when the resource areas are indicated as overlapping with each other, the UE transmits the SRS contiguously or non-contiguously in symbols before or after a short/long PUCCH transmission symbol. For this purpose, the BS may transmit an offset value indicating the position of an SRS transmission symbol to the UE by L1 signaing (DCI) or L3 signaling (higher-layer signaling such as RRC signaling). For example, when the offset value indicating the posiion of the SRS transmission symbol is 1 and the PUCCH transmission area is reserved in a corresponding symbol (with symbol index n), the UE may transmit the SRS in a symbol (symbol with symbol index n−1) earlier than the PUCCH transmisison symbol by one symbol and in a symbol (symbol with symbol index n+1) later than the PUCCH transmisison symbol by one symbol, based on the offset.
Case 2: In the case where the transmission area of a periodic short/long PUCCH is reserved and indicated as overlapped with the resource area of an SRS, when the SRS has priority over the short/long PUCCH in using symbols, the UE transmits the SRS in the symbols, while transmitting the short/long PUCCH in symbol(s) before or after the SRS transmission symbols. To indicate transmission of the short/long PUCCH in the symbol(s) before or after the SRS transmisison symbols, the BS may transmit an offset value indicating the position of the PUCCH transmission symbol related to the SRS transmission to the UE by L1 signaling (DCI) or L3 signaling (higher-layer signaling such as RRC signaling).
Case 3: In the case where the transmission area of a periodic SRS is reserved and an aperiodic short/long PUCCH is allocated in the SRS transmission area, the UE transmits the SRS in symbols before or after a short/long PUCCH transmission symbol. To indicate the symbols before or after the short/long PUCCH transmisison symbol, the BS may transmit an offset value indicating the position of an SRS transmission symbol to the UE by L1 signaling (DCI) or L3 signaling (higher-layer signaling such as RRC signaling).
Case 4: In the case where the transmission area of a periodic SRS is reserved and an aperiodic short/long PUCCH is allocated in the SRS transmission area, the UE may transmit the short/long PUCCH in symbol(s) before or after an SRS transmission symbol. To indicate the symbol(s) before or after the SRS transmisison symbol, the BS may transmit an offset value indicating the position of the short/long PUCCH transmission symbol to the UE by L1 signaling (DCI) or L3 signaling (higher-layer signaling such as RRC signaling).

Proposal 7

For the case where the UE transmits an SRS and a short/long PUCCH in FDM, the BS may configure different TCs and TC offsets for the SRS and the short/long PUCCH so that the UE may multiplex the SRS and the short/long PUCCH at a resource element (RE) level.

Proposal 8

When a periodic short/long PUCCH, an aperiodic short/long PUCCH, and an SRS are allocated (or configured) in the same slot, the aperiodic short/long PUCCH may be allocated in a symbol before a symbol carrying the periodic short/long PUCCH due to reservation of the transmission area of the periodic short/long PUCCH. When the SRS is allocated (or configured) in the symbol carrying the aperiodic short/long PUCCH, the SRS transmission may collide with the aperiodic short/long PUCCH collision. In this case, the following (1), (2), and (3) may be configured.
(1) TDM/FDM: The symbol may be reserved for the SRS and the position of the aperiodic short/long PUCCH may be configured implicitly in TDM or FDM. For example, the aperiodic short/long PUCCH may be allocated to a symbol before the periodic short/long PUCCH so that the aperiodic and periodic short/long PUCCHs are close to each other, while the SRS may be allocated to symbols before the aperiodic short/long PUCCH (TDM). Further, when a cell-centered UE, for example, is capable of securing transmission power enough to simultaneously transmit a short/long PUCCH and an SRS, the cell-centered UE may transmit the short/long PUCCH and the SRS in FDM. To determine whether this method is available, for example, the BS may determine how much pathloss (PL) is by estimating the PL of a UL channel. Let a minimum required power level for reception be denoted by η. On the assumption that the reception level is higher than η during transmission of the aperiodic short/long PUCCH, the reception level is higher than η during transmission of the SRS, and the aperiodic short/long PUCCH and the SRS are transmitted in FDM with half power for each, when the reception level is higher than η for each of the aperiodic short/long PUCCH and the SRS which are transmitted respectively with half power, the aperiodic short/long PUCCH and the SRS may be multiplexed in FDM. The FDMed positions of the aperiodic short/long PUCCH and the SRS may be pre-configured implicitly.
(2) The aperiodic short/long PUCCH may be transmitted in a slot following a slot carrying the SRS, and the position of the aperiodic short/long PUCCH may be implicitly configured in a next slot to the slot carrying the SRS.
(3) When an aperiodic short/long PUCCH transmission collides (or overlaps) with a periodic SRS transmission, the periodic SRS may be allocated in a time/frequency area other than the transmission area of the aperiodic short/long PUCCH.

FIG. 11 is a diagram illustrating exemplary TDM (implicit arrangement) among a periodic PUCCH, an aperiodic PUCCH, and a periodic SRS.

For example, when the aperiodic PUCCH is allocated to the 13^{th} symbol of a slot and the SRS is allocated to the 9^{th} to 13^{th} symbols of the slot in consideration of an aperiodic PUCCH area (the 14^{th} symbol), the aperiodic PUCCH transmission may collide with the periodic SRS transmission. In this case, the periodic SRS may be mapped to or configured in the 8^{th} to 12^{th} symbols.

Proposal 9

A resource allocation position pattern message for multiplexing between an aperiodic short/long PUCCH and a periodic/aperiodic SRS may be configured by higher-layer signaling (e.g., RRC signaling). The higher-layer signaling may also include priority information regarding collision. Table 16 describes exemplary resource allocation position patterns for multiplexing between an aperiodic short/long PUCCH and a periodic/aperiodic SRS.

TABLE 16

| Aperiodic PUCCH | |
|---|---|
| resource allocation | Aperiodic PUCCH resource allocation |
| position pattern index | position rule |
| 0 | Symbol before periodic PUCCH |
| 1 | Use allocated resources despite collision |
| | with SRS |
| 2 | Symbol before SRS symbols in case of |
| | collision with SRS |

The BS may transmit the index of an aperiodic PUCCH resource allocation position pattern to the UE by higher-layer signaling (L3 signaling), a MAC-CE, or DCI. For example, when the SRS is transmitted in a slot for which the index of the aperiodic PUCCH resource allocation pattern is 2, the number of SRS symbols is 4, and the SRS symbols are allocated to be 10^{th} to 14^{th} symbols, the 9^{th} symbol may be allocated for transmisison of the aperiodic PUCCH because the index of the aperiodic PUCCH resource allocation pattern is 2.

Proposal 10

Based on an event-triggered scheme, upon occurrence of a specific event (e.g., collision), the UE changes an existing resource allocation area according to the event and an aperiodic short/long PUCCH resource allocation rule and transmits an aperiodic PUCCH. Table 17 below lists exemplary PUCCH resource allocation position rules according to events+aperiodic PUCCH resource allocation position pattern indexes.

TABLE 17

| | aperiodic | |
|---|---|---|
| | PUCCH | |
| | resource | |
| | allocation | Aperiodic PUCCH |
| | position | resource allocation |
| Event | pattern index | position rule |
| When only SRS and | 0 | FDM with periodic SRS |
| aperiodic PUCCH are | | transmission symbol |
| transmitted in the slot, | 1 | Use allocated resources despite |
| periodic SRS transmission | | collision with SRS |
| symbol collides with | 2 | Symbol before SRS symbols in |
| aperiodic PUCCH. | | case of collision with SRS |
| When periodic PUCCH, | 0 | Symbol before periodic |
| periodic SRS, and | | PUCCH transmission symbol |
| aperiodic PUCCH are | 1 | Use allocated resources despite |
| transmitted, periodic SRS | | collision with SRS |
| collides with aperiodic | 2 | For aperiodic PUCCH, symbol |
| PUCCH. | | before SRS symbols in case of |
| | | collision with SRS |

The BS decodes UL resources in a corresponding slot based on a multiplexing pattern and an event triggering hypothesis. Because the BS has knowledge of transmission or non-transmission of a periodic/aperiodic PUCCH and a periodic/aperiodic SRS which are allocated to a specific UL slot and provides information about their resource allocation priorities, the BS may flexibly decode the UL slot/subframe. For example, it is assumed that a periodic PUCCH, an aperiodic PUCCH, and a periodic SRS are allocated in slot K. The BS knows that an aperiodic PUCCH resource allocation position pattern index of 2 has been transmitted, and thus performs decoding for the UL slot, understanding that SRS symbols follow an aperiodic PUCCH symbol, and the periodic PUCCH is allocated in the symbol following the SRS symbols.

Proposal 11

When a UL channel collides with an SRS transmission, the following priority rules are followed.

Resource allocation priority rule based on SRS usage and PUCCH configuration in case of collision between SRS transmission and PUCCH transmission

When an SRS resource allocation area overlaps with a PUCCH resource allocation area, a resource allocation priority rule is determined according to the usage of an SRS and a PUCCH configuration. When an SRS for beam management is allocated to multiple contiguous symbols (one SRS resource spans multiple symbols), different priority rules apply to TRP reception (Rx) beam sweeping (U2) and UE transmission (Tx) beam sweeping (U1 and U3). In the operation U2 (in which the sequence of an SRS symbol is generally transmitted repeatedly), when the resources of a PUCCH (particularly, a short PUCCH (a PUCCH allocated to one symbol) overlap with the SRS, the PUCCH is allocated to an overlapped symbol to which the SRS has been allocated, and the UE does not transmit the SRS in the symbol. In TRP Rx beam sweeping, therefore, the BS performs PUCCH decoding in the overlapped symbol without Rx beam sweeping mapped to the UL symbol.

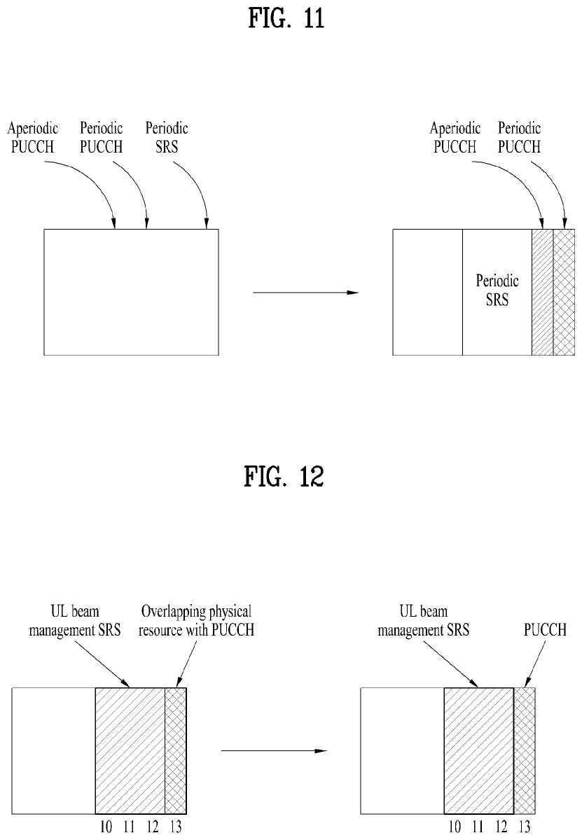

FIG. 12 is a diagram illustrating exemplary transmission in case of overlap between an SRS for Rx beam sweeping and a PUCCH.

Referring to the left drawing of FIG. 12, an SRS for UL beam management is allocated to symbol 10 (i.e., symbol index 10) to symbol 13, and a PUCCH is allocated to symbol 13. In this case, the UE does not transmit the SRS in symbol 13, while transmitting the PUCCH in symbol 13 as illustrated in the right drawing of FIG. 12. That is, the UE transmits the SRS only in symbols 10, 11, and 12.

In the operation U1 or U3 (in which different sequences are used between SRS symbols), when an SRS and a PUCCH overlap with each other, the UE does not transmit the PUCCH. Exceptionally, when important information such as an ACK/NACK or an SR is included in a PUCCH format (e.g., LTE PUCCH formats 0, 1, and so on), the UE transmits the PUCCH in the overlapped symbol (symbol 13), without transmitting the SRS in the symbol (or while dropping the SRS transmission in the symbol) as illustrated in FIG. 12. Alternatively, the UE may not transmit the SRS in any of multiple symbols. For example, the UE may not transmit the SRS which has been allocated across symbol 10 to symbol 13, in any of symbol 10 to symbol 13.

When an SRS configured for the purpose of CSI acquisition overlaps with a PUCCH, the UE does not transmit the PUCCH. Particularly for a long PUCCH (e.g., a PUCCH allocated to multiple symbols), when the resource allocation areas overlap fully or partially with each other, the UE does not transmit the PUCCH. Exceptionally, when important information such as an ACK/NACK or an SR is included in a PUCCH format (e.g., LTE PUCCH formats 0, 1, and so on), the UE transmits the PUCCH in an overlapped symbol, without transmitting the SRS in the symbol, as illustrated in FIG. 12. Alternatively, the UE may not transmit the SRS which are allocated to multiple symbols.

When a PUCCH which is transmitted repeatedly in n contiguous symbols (a PUCCH allocated to one symbol is copied to another symbol) overlaps with an SRS over all or part of the symbols, the UE does not transmit the overlapped PUCCH symbol(s).

FIG. 13 is a diagram illustrating exemplary partial overlap between an SRS and a PUCCH which is repeatedly transmitted in two symbols.

When a PUCCH is repeatedly transmitted in symbols 12 and 13 and an SRS is allocated to symbol 9 to symbol 13 as illustrated in FIG. 13, the UE transmits the SRS in symbol 9 to symbol 12, and the PUCCH in symbol 13. The UE does not transmit the PUCCH in symbol 12 (the overlapped symbol between the SRS and the PUCCH).

The above-described resource allocation priority rule based on an SRS usage and a PUCCH configuration is summarized below in Table 18.

TABLE 18

| Case of transmission overlap | |
|---|---|
| (or collision) in specific symbol | Priority-based transmission |
| 1. SRS for UE Tx beam sweeping | Not transmit PUCCH |
| and PUCCH | |
| 2. SRS for TRP Rx beam sweeping | Not transmit SRS in overlapped |
| and PUCCH | symbol |
| 3. SRS for CSI acquisition and | Not transmit PUCCH |
| PUCCH (particularly long PUCCH) | |
| 4. SRS for CSI acquisition and | Not transmit SRS in overlapped |
| PUCCH including ACK/NACK or | symbol or in any of multiple |
| SR | symbols/transmit PUCCH |
| 5. PUCCH allocated to n | Not transmit PUCCH in |
| contiguous symbols and SRS | overlapped symbol |

Resource Allocation Priority Rule Based on Transmission Configuration in Case of Collision Between SRS Transmission and PUCCH Transmission

When an SRS resource allocation area overlaps with a PUCCH, a resource allocation priority rule is determined according to an SRS/PUCCH transmission configuration.

When the resource area of a periodic SRS overlaps with the resource area of an aperiodic PUCCH, it is determined that the aperiodic PUCCH has priority over the periodic SRS. That is, the UE does not transmit the periodic SRS overlapped with a symbol to which the aperiodic PUCCH is allocated. For an SRS for UL beam management, information about candidate beams mapped to the SRS symbol may be mapped in the next SRS configuration. For an SRS for UL CSI acquisition, an SRS for sounding may not be transmitted in an overlapped symbol, or may be allocated to corresponding SRS resources in the next SRS configuration. When it is possible to simultaneously transmit an aperiodic PUCCH and a periodic SRS with power at or below a UL transmission power limit (in consideration of a PAPR/CM), the periodic SRS may be multiplexed in FDM in a frequency resource other than the aperiodic PUCCH resource area. An FDM rule may be predefined.

Exceptionally, when the aperiodic PUCCH does not include important information such as an ACK/NACK and an SR, the UE may transmit the periodic SRS in the overlapped symbol, without transmitting the aperiodic PUCCH in the overlapped symbol.

When a periodic SRS transmission collides with a periodic PUCCH transmission (transmission of a PUCCH format with payload larger than a predetermined size), the periodic SRS has priority over the periodic PUCCH. Among periodic PUCCHs, a PUCCH format with payload larger than a predetermined size may generally carry beam-related information. Because a PUCCH carrying information such as a CQI, a PMI, an RI, a PQI, or a CRI may have a format determined according to its payload, may be piggybacked to UCI of a PUSCH, or may be transmitted on a PUSCH, for higher-layer (L2 (MAC-CE)) transmission, the PUCCH may be set to a lower priority level than the periodic SRS. When a PUCCH transmisison in a PUCCH format with payload larger than a predetermined size collides with a periodic SRS transmisison, the UE may not transmit the PUCCH (in an overlapepd symbol) or may transmit the PUCCH in the next PUCCH configuration.

From the perspective of transmission, a periodic PUCCH in a resource area overlapped with that of a periodic SRS, which has payload less than a predetermiend size, has priority over the periodic SRS. Basically, the PUCCH with payload less than the predetermiend size may include important information (e.g., an ACK/NACK or an SR). In this case, the UE transmits the periodic PUCCH, without transmitting the periodic SRS. Alternatively, the UE may transmit the periodic SRS in a symbol before the periodic PUCCH or in a specific symbol. The BS may transmit information about the position of the SRS transmitted before the periodic PUCCH in the form of a symbol index or an offset value to the UE by higher-layer siganling (L3), L1 signaling (DCI), or L2 signaling (MAC-CE) (e.g., when PUCCH symbol=14^{th} and offset=4, the SRS is allocated to the 9^{th} symbol).

When the resource area of a semi-persistent SRS overlaps with the resource area of an aperiodic PUCCH, it is determined that the aperiodic PUCCH has priority over the semi-persistent SRS in terms of transmission. Exceptionally, when the periodic PUCCH does not include important informaiton such as an ACK/NACK or an SR, the semi-persistent SRS has priority over the aperiodic PUCCH in terms of transmisison, and the UE does not transmit the aperiodic PUCCH.

When the resource area of a semi-persistent SRS overlaps with the resource area of a periodic PUCCH and the periodic PUCCH is in a PUCCH format with payload larger than a predetermined size, it is determined that the semi-persistent SRS has priority over the periodic PUCCH in terms of transmisison. In this case, the UE transmits the semi-persistent SRS without the periodic PUCCH in the PUCCH format with payload larger than the predetermiend size, in the overlapped resource area. When the periodic PUCCH is in a PUCCH format with payload less than the predetermiend size, it is determined that the periodic PUCCH has priority over the semi-persistent SRS in terms of transmisison. In this case, the UE transmits the periodic PUCCH in the PUCCH format with payload less than the predetermiend size without the semi-persistent SRS, in the overlapped resource area.

When an aperiodic SRS transmission overlaps with a periodic PUCCH transmisison, an aperiodic SRS is allocated with priority over a periodic PUCCH. Exceptionally, when the periodic PUCCH includes important information such as an ACK/NACK and/or an SR, the UE transmits the periodic PUCCH without the aperiodic SRS in an overlapped resource area. When the UE is capable of simultaneously transmitting the aperiodic SRS and the periodic PUCCH at or below a UL transmission power limit (in consideration of a PAPR/CM), the UE may multiplex the periodic PUCCH in FDM in a frequency resource other than the resource area of the aperiodic SRS. An FDM rule may be predefined.

When the resource allocation area of an aperiodic SRS overlaps with the resource allocation area of an aperiodic PUCCH, the aperiodic PUCCH is allocated with priority over the aperiodic SRS. When the resource allocation area of an aperiodic SRS overlaps with the resource allocation area of an aperiodic PUCCH, the UE transmits the aperiodic PUCCH without the aperiodic SRS in an overlapped resource area. Exceptionally, when the aperiodic SRS is used for Tx beam sweeping (U1 or U3) in UL beam management, the UE transmits the aperiodic SRS without the aperiodic PUCCH in the overlapped resource area.

When an aperiodic SRS is allocated to multiple symbols and an aperiodic PUCCH overlaps with a partial resource area of the aperiodic SRS, the UE transmits the aperioic PUCCH without the aperiodic SRS in an overlapped symbol.

Table 19 below summarizes the above-described resource allocation priority rule based on SRS/PUCCH transmission configurations.

TABLE 19

| Case of overlap (or collision) | |
|---|---|
| between transmissions in specific | |
| symbol | Priority-based transmission |
| 1. Periodic SRS/aperiodic | Not transmit periodic SRS |
| PUCCH | |
| 2. Periodic SRS/aperiodic | Transmit SRS without aperiodic |
| PUCCH without ACK/NACK or | PUCCH in overlapped symbol |
| SR | |
| 3. Periodic SRS/periodic | Not transmit PUCCH |
| PUCCH with payload larger than | |
| predetermined size | |
| 4. Periodic SRS/periodic | Transmit PUCCH/not transmit |
| PUCCH with payload less than | periodic SRS |
| predetermined size | |
| 5. Semi-persistant SRS/aperiodic | Transmit PUCCH/Not transmit |
| PUCCH | semi-persistant SRS |
| 6. Semi-persistant SRS/aperiodic | Transmit semi-persistant |
| PUCCH (without ACK/NACK | SRS/Not transmit PUCCH |
| and/or SR) | |
| 7. Semi-persistant SRS/periodic | Transmit semi-persistant SR/not |
| PUCCH (PUCCH format with | transmit PUCCH format with |
| payload larger than predetermined | payload larger than |
| size) | predetermined size |
| 8. Semi-persistant SRS/periodic | Transmit PUCCH format with |
| PUCCH (PUCCH format with | payload less than predetermined |
| payload less than predetermined | size/not transmit semi-persistant |
| size) | SRS |
| 9. Aperiodic SRS/periodic | Transmit aperiodic SRS |
| PUCCH | |
| 10. Aperiodic SRS/periodic | Not transmit aperiodic SRS/ |
| PUCCH (without ACK/NACK | transmit periodic PUCCH |
| or SR) | |
| 11. Aperiodic SRS/aperiodic | Transmit aperiodic PUCCH/not |
| PUCCH | transmit aperiodic SRS |
| 12. Aperiodic SRS for Tx beam | Not transmit aperiodic PUCCH/ |
| sweeping of UL beam | transmit aperiodic SRS |
| management (U1 or U3)/ | |
| aperiodic PUCCH | |

Resource Allocation Priority Rule Based on Information about PUCCH Transmission in Case of Collision Between SRS Transmisison and PUCCH Transmission

When the resource allocation area of an SRS overlaps with the resource allocation area of a PUCCH, a resource allocation priority rule may be determined according to SRS/PUCCH transmission information.

When a short/long PUCCH is used for a beam failure-related request (e.g., a beam failure recovery request) and overlaps with an aperiodic/periodic/semi-persistent SRS, the UE transmits the short/long PUCCH used for a beam failure-related request (e.g., a beam failure recovery request) without the aperiodic/periodic/semi-persistent SRS in overlapped symbol(s).

The PUCCH transmitted for a beam failure-related request (e.g., a beam failure recovery request) always has priority over the aperiodic/periodic/semi-persistent SRS in terms of resource allocation. Accordingly, when the PUCCH transmitted for a beam failure-related request (e.g., a beam failure recovery request) partially overlaps with the aperiodic/periodic/semi-persistent SRS, the UE does not transmit the SRS. The PUCCH transmitted for a beam failure-related request (e.g., a beam failure recovery request) may not be multiplexed in FDM with the aperiodic/periodic/semi-persistent SRS, and the UE does not transmit the SRS.

The methods of multiplexing an SRS with a PUCCH during resource allocation between the SRS and the PUCCH in NR, particularly SRS frequency hopping has been described above. When SRS frequency hopping is performed, the SRS may collide with the FDMed PUCCH. To avoid the collision, there is a need for multiplexing the allocated PUCCH with the SRS in FDM or TDM in consideration of symbol-level or slot-level SRS hopping. Further, when the SRS transmisison overlaps or collides with the PUCCH transmission, one of the SRS and the PUCCH may be transmitted according to a predefined resource allocaiton priority rule.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with other claims referring to the other claims other than the specific claims to constitute the embodiment or add new claims by means of amendment after the application is filed.

Those skilled in the art will appreciate that the present invention may be carried out in other specific ways than those set forth herein without departing from the spirit and essential characteristics of the present invention. The above exemplary embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

1. A method of transmitting a signal according to a resource allocation priority by a user equipment (UE), the method comprising:
when sounding reference signal (SRS) symbols and a physical uplink control channel (PUCCH) symbol are configured to overlap with each other, transmitting an SRS in a non-overlapped symbol; and
dropping an SRS transmission in an overlapped symbol.

2. The method according to claim 1, further comprising transmitting the PUCCH symbol in the overlapped symbol.

3. The method according to claim 1, wherein the SRS symbols include a plurality of consecutive symbols.

4. The method according to claim 1, wherein the PUCCH symbol is a periodic PUCCH symbol.

5. The method according to claim 1, wherein the PUCCH symbol is an aperiodic PUCCH symbol.

6. A method of transmitting a signal according to a resource allocation priority by a user equipment (UE), the method comprising:
when an aperiodic sounding reference signal (SRS) and a physical uplink control channel (PUCCH) for a request related to beam failure are configured to overlap with each other in a resource area, transmitting the PUCCH for the request related to beam failure; and
dropping a transmission of the aperiodic SRS.

7. The method according to claim 6, wherein the PUCCH for the request related to beam failure is a short PUCCH.

8. A user equipment (UE) for transmitting a signal according to a resource allocation priority, the UE comprising:
a transmitter; and
a processor,
wherein the processor is configured to, when sounding reference signal (SRS) symbols and a physical uplink control channel (PUCCH) symbol are configured to overlap with each other, control the transmitter to transmit an SRS in a non-overlapped symbol and drop an SRS transmission in an overlapped symbol.

9. The UE according to claim 8, wherein the processor controls the transmitter to transmit the PUCCH symbol in the overlapped symbol.

10. The UE according to claim 8, wherein the SRS symbols include a plurality of consecutive symbols.

11. The UE according to claim 8, wherein the PUCCH symbol is a periodic PUCCH symbol.

12. The UE according to claim 8, wherein the PUCCH symbol is an aperiodic PUCCH symbol.

13. A user equipment (UE) for transmitting a signal according to a resource allocation priority, the UE comprising:
a transmitter; and
a processor,
wherein the processor is configured to, when an aperiodic sounding reference signal (SRS) and a physical uplink control channel (PUCCH) for a request related to beam failure are configured to overlap with each other in a resource area, control the transmitter to transmit the PUCCH for the request related to beam failure and drop a transmission of the aperiodic SRS.

14. The UE according to claim 13, wherein the PUCCH for the request related to beam failure is a short PUCCH.
